(19) United States
(12) Patent Application Publication
(10) Pub. No.: US 2002/0147781 A1
(43) Pub. Date: Oct. 10, 2002

(54) Information providing server

(75) Inventors: Yoshihiko Akasaka, Nagano-ken (JP); Kenji Akahane, Nagano-ken (JP)

Correspondence Address: SUGHRUE MION, PLLC, 2100 Pennsylvania Avenue, NW, Washington, DC, 20037-3213, US

(73) Assignee: SEIKO EPSON CORPORATION

(21) Appl. No.: 10/104,050

(22) Filed: Mar. 25, 2002

(30) Foreign Application Priority Data
Mar. 27, 2001 (JP) 2001-090332
Mar. 27, 2001 (JP) 2001-090333

(51) Int. Cl. G06F 15/16

(52) U.S. Cl. 709/206

(57) ABSTRACT

When a demand to provide document information is made from clients through a network, document information in which the access right of display permission has been established is retrieved on the basis of a user ID, which has been input when the user has performed a login procedure, and on the basis of a retrieval condition which has been input by use of a displayed retrieval screen, and a retrieval-result-list-displaying screen that displays only the list of the retrieved documents is formed and displayed. As a result, the document information that is provided in accordance with the access right can be more appropriately displayed in the form of a list, and clients can easily select providable information.

### BACKGROUND OF THE INVENTION

1. Field of the Invention

The present invention relates to an information providing server, an information providing method, etc., for providing information to clients through a network.

2. Description of the Related Art

Conventionally, a server used to provide information for which an access right has been established on the basis of the access right has been proposed as an information providing server over a network. In this server, a list of the information is displayed, and, at the same time, a part of the information that cannot be provided according to the access right is marked as not being capable of being provided. For example, when the information list is displayed, information that can be provided on the basis of the access right is thickly displayed and is designed to have an information-providable mark (e.g., hand mark) displayed instead of a pointing device, whereas information that cannot be provided on the basis thereof is thinly displayed and is designed to have no information-providable mark by the pointing device.

However, in the information providing server, the information that cannot be provided on the basis of the access right is also displayed thinly in the form of a list, and therefore a list-displaying screen becomes large, and a case occurs in which providable information cannot be chosen easily. Especially if the access authority of a client is small, most of the information displayed on the list-displaying screen is not provided, and it will become difficult to choose providable information.

Additionally, in this information providing server, a distinction cannot be drawn inmost cases between new information and old information that has been conventionally provided among the providable information though the providable information can be found on the basis of the access right. As a solution to these problems, a specific mark, such as “new”, is given to the new information that can be provided. However, it is impossible to know whether or not the new information has begun to be provided unless the information providing server is actually accessed.

### SUMMARY OF THE INVENTION

An object of the present invention is to more appropriately display a list of information that is provided according to an access right and to allow a client to be able to easily choose providable information. Another object of the present invention is to, when new providable information is generated, transmit the contents to a registered client and to, on the basis of an access right of the registered client, transmit a notification to the effect that new providable information has been generated.

In order to achieve at least a part of the aforementioned objects, an information providing server, an information providing method, etc., of the present invention have been structured as follows.

A first information providing server of the present invention is an information providing server that provides information to a client through a network, and the first information providing server includes: an information storage part for storing predetermined information that includes an access right as a part of the information; an information retrieval part for, when a client demands that the predetermined information be provided through the network, retrieving information to be provided from the predetermined information stored in the information storage part on the basis of the access right of the client concerning the demand; a display screen forming part for forming a display screen of a list of retrieved information; and a display screen providing part for providing a list-displaying screen that has been formed to the client concerning the demand.

In the first information providing server of the present invention, when the client demands that the predetermined information be provided through the network, information to be provided is retrieved from the predetermined information stored in the information storage means on the basis of the access right of the client concerning the demand, and a list-displaying screen that displays a list of the retrieved information is formed and is provided to the client concerning the demand. Since the predetermined information is retrieved on the basis of the access right, and the list thereof is displayed, the list of the predetermined information can be more appropriately displayed. As a result, the client can easily choose providable information.

As an aspect, in the first information providing server of the present invention, the display screen forming part may be designed to form a list-displaying screen that displays a list of only the retrieved information. As another aspect, the predetermined information may include its group as a part of the information, and the display screen forming part may form a list-displaying screen in which a list of retrieved information is displayed on the basis of the group to which the information belongs, with one group as a unit. As still another aspect, the display screen forming part may form a list-displaying screen in which any of the retrieved information can be chosen, and there may be provided an information providing part for, when a client concerning a demand chooses information by use of the list-displaying screen, providing the chosen information to the client concerning the demand. As still another aspect, the predetermined information may include the time at which information begins to be provided as a part of the information, and the information retrieval part may retrieve information that has reached the provided time from among the predetermined information. In this case, the provided time at which information begins to be provided may be set as a provided disclosure date. Document information can be mentioned as the predetermined information.

A second information providing server of the present invention is an information providing server that can provide information to a registered client through a network, and the second information providing server includes: an information storage part for storing document information about a plurality of documents that includes an access right of the client and a document disclosure date, each as a part of the document information; a retrieval part for retrieving document information that has reached the disclosure date from among the document information stored in the information storage part; a client extraction part for extracting a client having an access right with respect to the retrieved document information; and a mail creation part for creating mail that includes a notification of the retrieved document information for the extracted client.

In the second information providing server of the present invention, mail that includes a notification of document information is created for a client having an access right with respect to the document information that has reached a disclosure date, and therefore the client can know that the client can receive the document information that has reached the disclosure date when receiving the mail.

A third information providing server of the present invention is an information providing server that can provide information to a registered client through a network, and the third information providing server includes: an information storage part for storing predetermined information that includes the time at which information is provided as a part of the information; an information retrieval part for retrieving predetermined information that has reached the provided time from among the predetermined information stored in the information storage part; and a message-outputting part for outputting to the registered client a message to the effect that the predetermined information is provided, when the predetermined information that has reached the provided time is retrieved.

In the third information providing server of the present invention, predetermined information that has reached the provided time is retrieved from among the predetermined information stored in the information storage part, and a message to the effect that the retrieved predetermined information is provided is output to the registered client. As a result, the client can be informed that new providable information has been generated, without accessing the server from the client side. The provided time may be set as an information providing date.

A fourth information providing server of the present invention is an information providing server that can provide information to a registered client through a network, and the fourth information providing server includes: an information storage part for storing predetermined information that has been output from another server; and a message-outputting part for, at the time at which the predetermined information is stored in the information storage part and/or at a predetermined time after the predetermined information has been stored, outputting to the registered client a message to the effect that the predetermined information is provided.

In the fourth information providing server of the present invention, at the time at which predetermined information that has been output from another server is stored in the information storage part and/or at a predetermined time after the predetermined information has been stored, a message to the effect that the predetermined information is provided is output to the registered client. As a result, the client can be informed that new providable information has been generated, without accessing the server from the client side.

As an aspect, in the third and fourth information providing servers of the present invention, the message-outputting part can create an e-mail having a message to the effect that predetermined information to be stored in the information storage part is provided, and this e-mail can be transmitted to registered clients. As another aspect, the predetermined information includes a client's access right as a part of the information, and the message-outputting part can output a message to one of the registered clients who has obtained information provision permission in accordance with the client's access right that is partly included in the retrieved predetermined information.

In addition to these aspects of the information providing server, the present invention can be embodied in a form of a storage medium that stores a program according to which a computer is caused to function as the information providing server of the present invention or in a form of an information providing method resulting from regarding the manner of information provision by the information providing server of the present invention as a method.

Further, the present invention can be embodied in a form of an information provision site for providing predetermined information to a client through a network, i.e., in a form of a site that includes a demand reception page for receiving a demand that predetermined information be provided and a list-displaying page for retrieving related predetermined information from an information storage part that stores predetermined information on the basis of an access right that has been established for a client concerning the demand when the demand is received and for forming and displaying a screen of a list of the retrieved information.

### BRIEF DESCRIPTION OF THE DRAWINGS

FIG. 1 is a schematic diagram showing the structure of a double-server system 30, which includes first and second information providing servers 32 and 42, which is an embodiment of the present invention.

FIG. 2 is a schematic diagram showing the structure of the first information providing server 32 in a first embodiment of the present invention.

FIG. 3 is a schematic diagram showing the structure of the second information providing server 42 in a second embodiment of the present invention.

FIG. 4 is an explanatory diagram showing an example of a user registration dialog.

FIG. 5 is an explanatory diagram showing an example of a product model registration dialog.

FIG. 6 is an explanatory diagram showing an example of a document registration dialog.

FIG. 7 is a flowchart showing an example of a document-download processing routine performed by the first information providing server 32.

FIG. 8 is a flowchart showing an example of a mail creation/transmission processing routine performed by the first information providing server 32.

FIG. 9 is an explanatory diagram showing an example of created mail.

FIG. 10 is an explanatory diagram showing an example of mail that has been created for a user different from the example of FIG. 9.

FIG. 11 is a flowchart showing an example of a mail creation/transmission processing routine performed by the second information providing server 42.

FIG. 12 is a flowchart showing an example of a document retrieval/display processing routine performed when a list of documents that can be provided to a client that has performed a login procedure is displayed.

FIG. 13 is an explanatory diagram showing an example of a retrieval screen.

FIG. 14 is an explanatory diagram showing an example of a retrieval result display screen.

FIG. 15 is an explanatory diagram showing an example of a retrieval result display screen, which is formed for and is output to a user, different from the retrieval result display screen of FIG. 14.

FIG. 16 is an explanatory diagram showing an example of a display screen of a document.

FIG. 17 is a schematic diagram showing the structure of a modification of the first information providing server 32.

FIG. 18 is a schematic diagram showing the structure of a modification of the second information providing server 42.

### DETAILED DESCRIPTION OF THE PREFERRED EMBODIMENTS

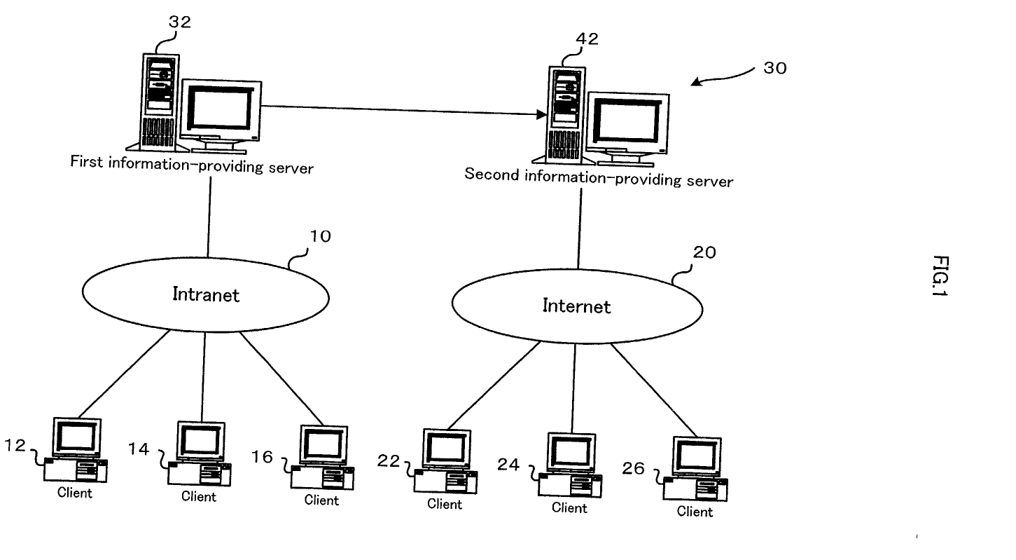

Preferred embodiments of the present invention will be described hereinafter. FIG. 1 is a schematic diagram showing the structure of a double-server system 30 that includes a first information providing server 32 and a second information providing server 42, each as an embodiment of the present invention. The double-server system 30 is made up of the first information providing server 32, which is a first embodiment, that can provide information to an intranet 10 to which clients 12 to 16 are connected and the second information providing server 42, which is a second embodiment, that can provide information to the Internet 20 to which clients 22 to 26 are connected. Information that is provided from the second information providing server 42 of the second embodiment to clients 22 to 26 connected to the Internet 20 can be output from the first information providing server 32 of the first embodiment to the second information providing server 42. In the double-server system 30, a description is given on the supposition that document information, which consists of documents and information annexed to the documents, is provided from the first information providing server 32 or the second information providing server 42 to the intranet 10 or the Internet 20.

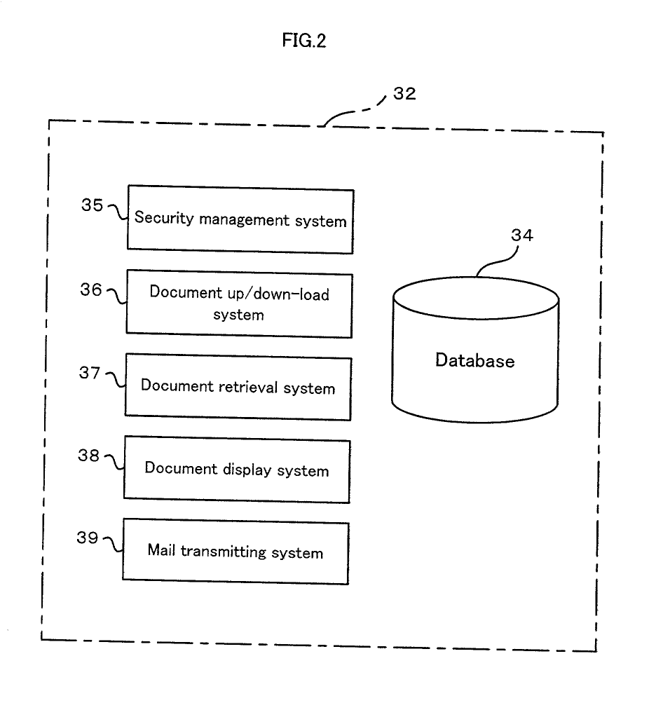

FIG. 2 is a schematic diagram showing the structure of the first information providing server 32 which is the first embodiment. As shown in the figure, the first information providing server 32 is basically made up of a database 34 for storing document information in database form, a security management system 35 for establishing an access right to documents, an access right for clients 12 to 16 having access to the first information providing server 32 of the first embodiment through the intranet 10 and an access right for clients 22 to 26 having access to the second information providing server 42 of the second embodiment through the Internet 20, a document up/down-load system 36 for uploading documents to the database 34 and downloading documents to the second information providing server 42, a document retrieval system 37 for retrieving documents stored in the database 34 in accordance with a demand from clients 12 to 16, a document-displaying system 38 for displaying and outputting a list of retrieved documents or documents chosen from the document list to the side of clients 12 to 16, and a mail-transmitting system 39 for creating and transmitting, to registered clients, mail to the effect that document information by which an information provision is newly performed has been generated.

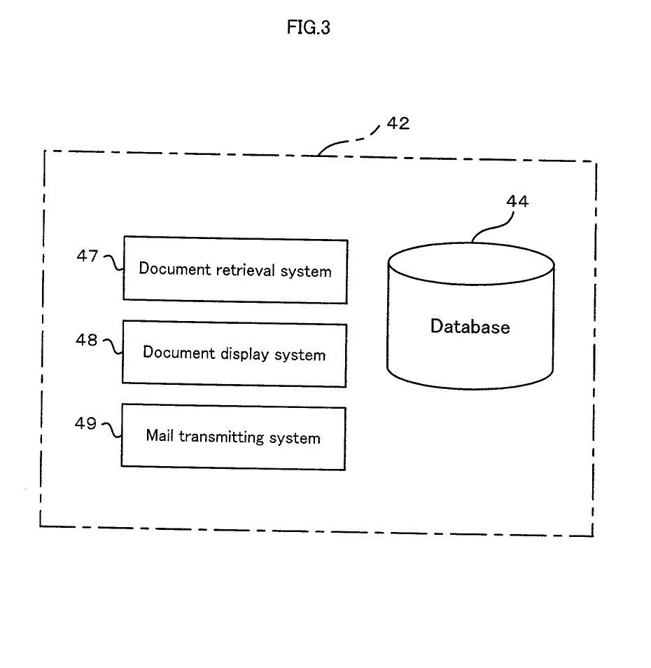

FIG. 3 is a schematic diagram showing the structure of the second information providing server 42 which is the second embodiment. As shown in the figure, the second information providing server 42 of the second embodiment is basically made up of a database 44 for storing document information that has been downloaded from the first information providing server 32 of the first embodiment in database form, a document retrieval system 47 for retrieving the documents stored in the database 44 in accordance with a demand from clients 22 to 26, a document-displaying system 48 for displaying and outputting a list of retrieved documents or documents chosen from the document list to the side of clients 22 to 26, and a mail-transmitting system 49 for creating and transmitting, to registered clients, mail to the effect that document information by which an information provision is newly performed has been generated.

Each of the first and second information providing servers 32 and 42 according to the first and second embodiment may be formed of a plurality of computers or may be formed of a single computer. This is derived not from a viewpoint of visual appearance but from a functional viewpoint. This means that the server can function as a plurality of computers having a plurality of CPUs inside, and, if it is a single unit in appearance, it can be regarded as a plurality of computers or as a single computer.

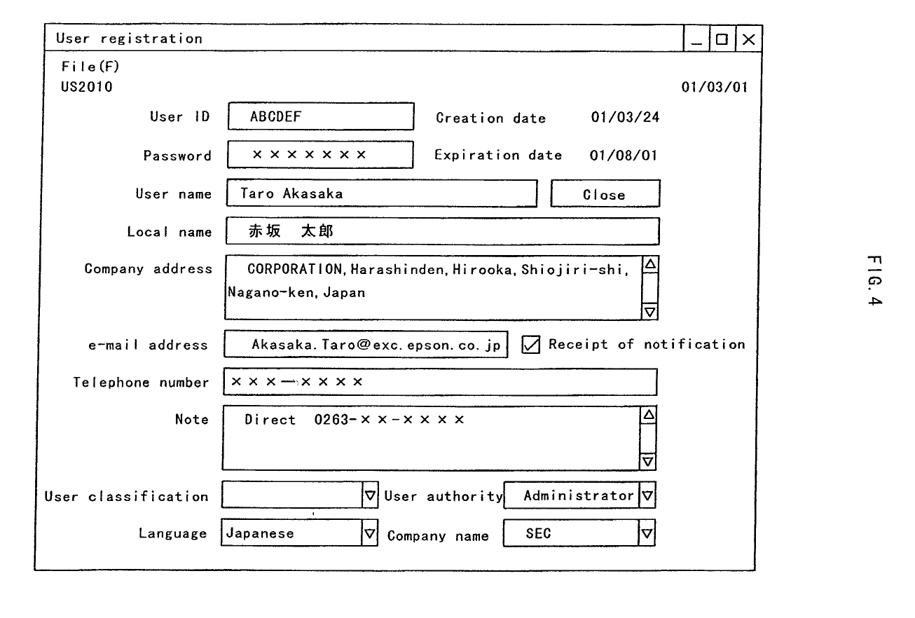

User management data, product model management data, and document management data are each registered in the database 34 of the first information providing server 32 of the first embodiment in database form. The user management data is input by use of, for example, the user registration dialog of FIG. 4. In the example of the user registration dialog of FIG. 4, items to be input for registration of a user are user classification, user authority, language, company name, and so on, in addition to password, user name, local name, company address, e-mail address, and telephone number. A classification according to which users are classified into groups is arranged beforehand, and a group to which a user belongs is chosen from a pull-down menu and is input into the input box of “User Classification”. Access rights, such as permission to upload a document, establishment of an access right, and change permission, are chosen from the pull-down menu and are input into the input box of “User Authority”.

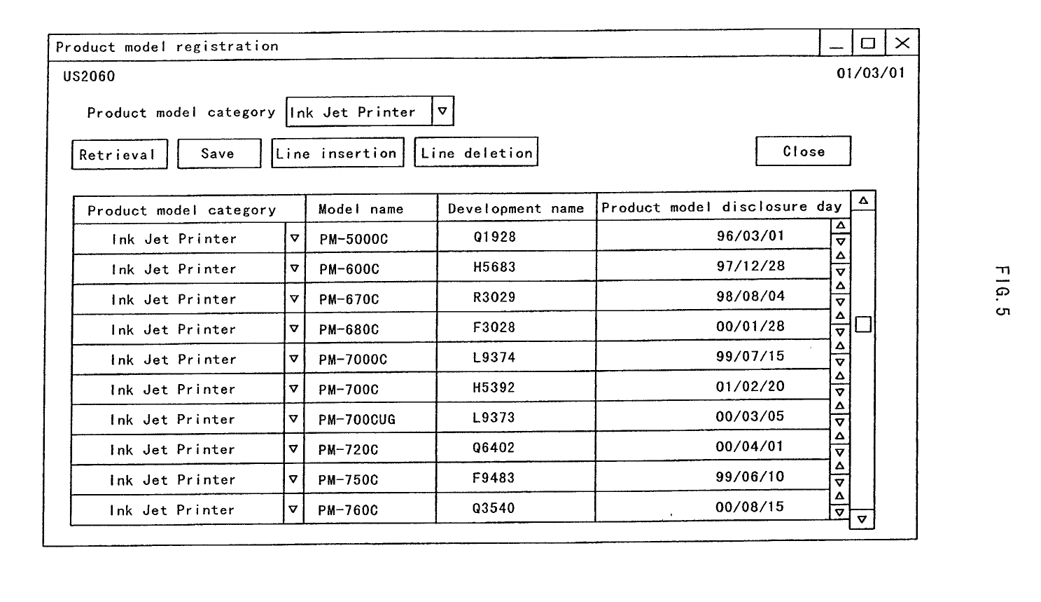

The product model management data is input by use of, for example, the product model registration dialog of FIG. 5. In the example of the product model registration dialog of FIG. 5, items to be input for registration of a product model are product category, model name, development name, product disclosure date, and so on, which are input directly or by selection from the pull-down menu.

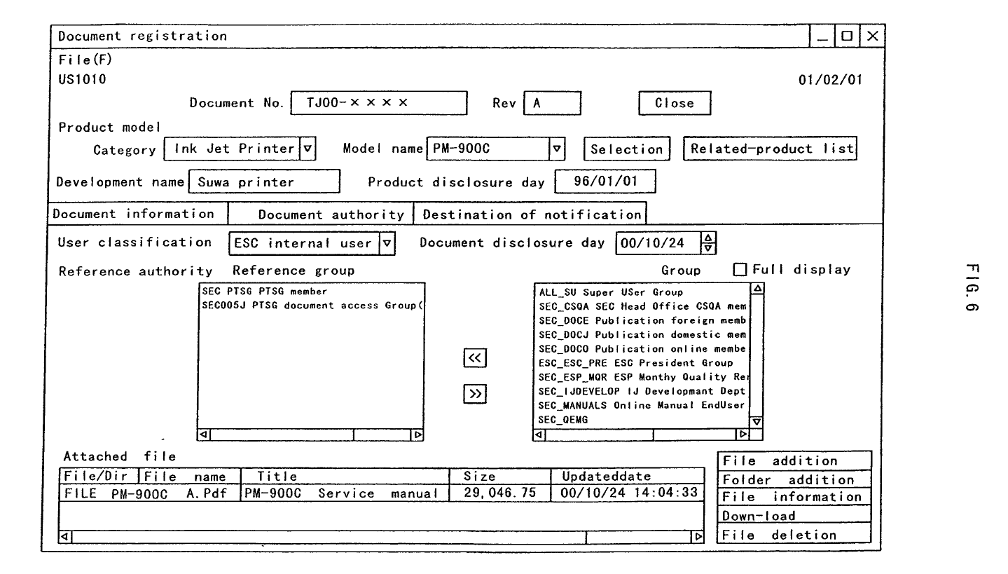

The document management data is input by use of, for example, the document registration dialog of FIG. 6. The document registration dialog of FIG. 6 shows a state in which the document uploading is completed, and document authority is in the process of being input. The document uploading is performed such that, in the document registration dialog, data is directly input into the input boxes of “Document No.” and Rev” of “File” and into the input boxes of “Category” and “Model Name” of “Product Model” or, alternatively, data is input according to the pull-down menu, and, at the same time, the tag of “Document Information” is chosen to input various information. The document authority is input such that the tag of “Document Authority” is chosen, and items are input into the input boxes of “User Classification”, “Document Disclosure Date”, and “Reference Group” by selection from the pull-down menu or from a list. Herein, “User Classification” is a broad classification of users (i.e., clients) having access to the first and second information providing servers 32 and 42 through the intranet 10 or the Internet 20. In this embodiment, clients of the intranet 10 are classified into system management users who can carry out system management and intranet users other than the system management users, whereas clients of the Internet 20 are classified as Internet users having access to the second information providing server 42. Both the classification with respect to the intranet 10 and the classification with respect to the Internet 20 can be merely made by selection according to the pull-down menu. “Reference Group” is a sub-classification used to further classify the users (clients) who belong to items selected by “User Classification”, and is set by, for example, “User Classification” of the user registration dialog of FIG. 4. In this embodiment, “Reference Group” can be input by selection from the list appearing on the right side of the figure. Through the selection in “User Classification” and “Reference Group”, an access right, which is a permission to display this document, can be established by use of the broad classification and the sub-classification. A date at which an input document begins to be disclosed to a client having access through the intranet 10 or the Internet 20 is input into the input box of “Document Disclosure Date”.

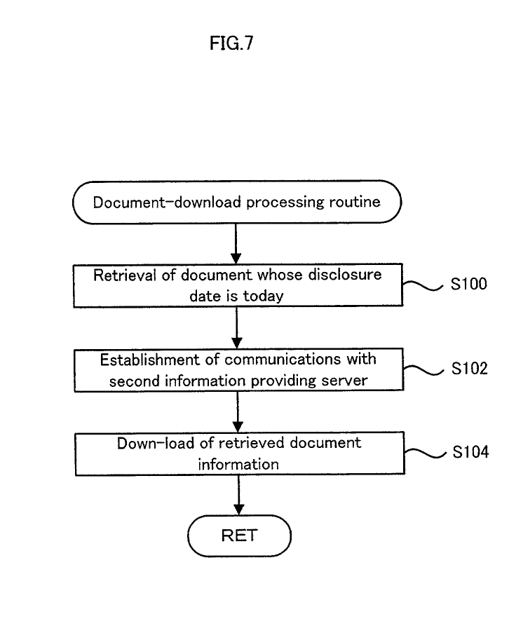

As in the database 34, user management data, product model management data, and document management data are each registered in the database 44 of the second information providing server 42 of the second embodiment in database form. Among these data, data pertinent to a predetermined time (e.g., 10 a.m.) of a document disclosure date is downloaded from the first information providing server 32 of the first embodiment, and is registered in the database 44 of the second information providing server 42. FIG. 7 is a flowchart showing an example of a document-download processing routine performed by the first information providing server 32. In performing this routine, the first information providing server 32 first accesses the database 34, then retrieves document information whose document disclosure date is today among the registered document information (Step S100), and performs processing for establishing communications with the second information providing server 42 (Step S102). Thereafter, the document information that has been retrieved as information whose document disclosure date is today is output to the second information providing server 42, i.e., is downloaded thereto (Step S104), and the routine is ended. The second information providing server 42 registers the document information output from the first information providing server 32 in the database 44. An access right (document authority) as well as a document is included in document information to be downloaded to the second information-providing server 42. In this embodiment, the document information whose document disclosure date is today is retrieved from among the document information, the processing for establishing communications with the second information providing server 42 is then performed, and the retrieved document information is downloaded. However, since the communications with the second information providing server 42 can be established before downloading, it may be established before or after the document information is retrieved.

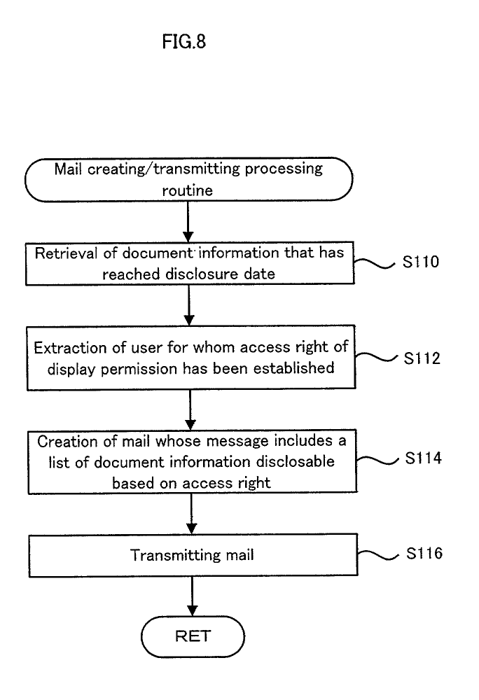

A description will now be given of processing for creating and transmitting, to a registered client, mail to the effect that document information that has reached a document disclosure date has been generated in the first information providing server 32 of the first embodiment constructed as above. FIG. 8 is a flowchart showing an example of a mail creation/transmission processing routine performed by the first information providing server 32. This routine is performed at a predetermined time (e.g., 10 a.m.) every day.

When the mail creation/transmission processing routine is performed, the first information providing server 32 first accesses the database 34, and performs processing for retrieving document information that has reached a document disclosure date (Step S110). Thereafter, a user (client) for whom an access right of display permission has been established by the document authority of retrieved document information, i.e., a user who belongs to a group chosen as a reference group of the document registration dialog of FIG. 6 is extracted (Step S112), and mail is created that includes a message about a list of document information disclosable based on the access right of the user who has been extracted (Step S114). Thereafter, the mail is transmitted to the destination of the mail, i.e., to the user's e-mail address (which has been input in the user registration dialog of FIG. 4) (Step S116), and this routine is ended.

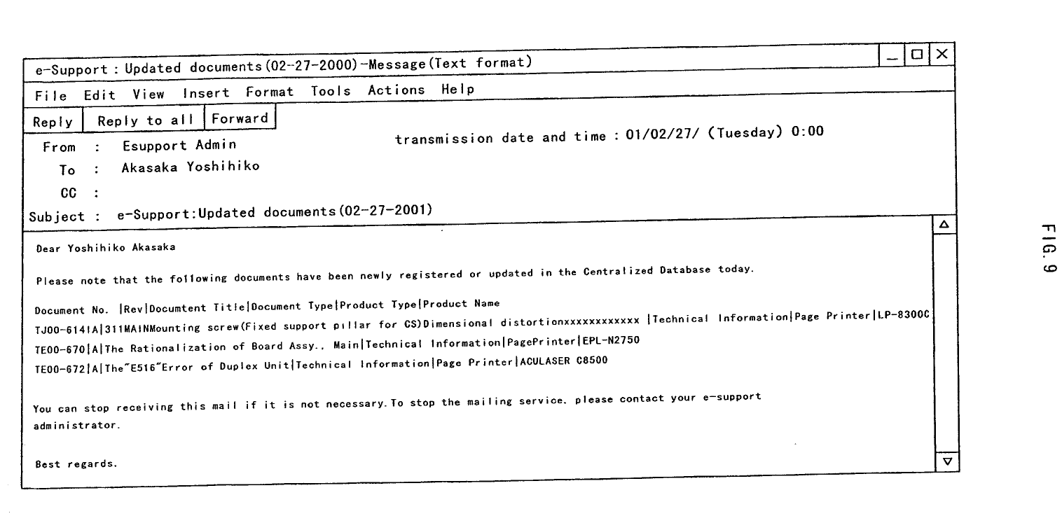

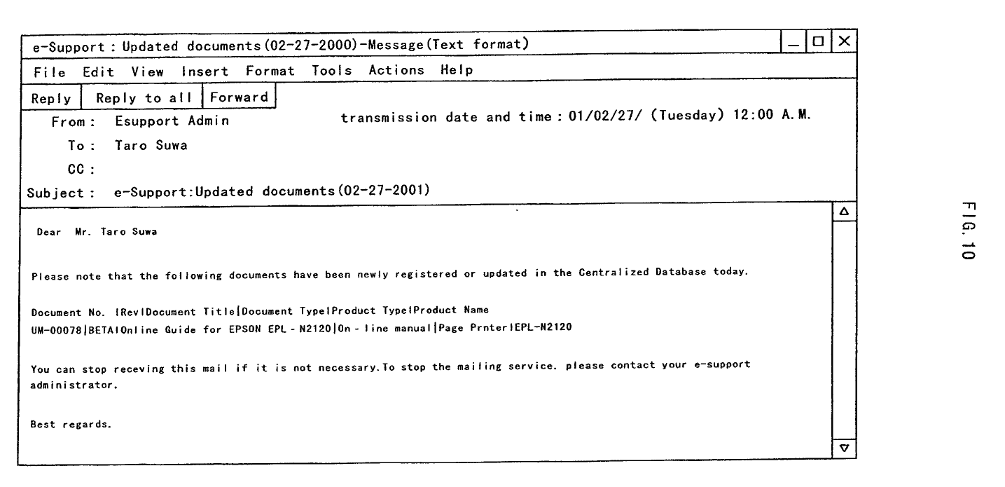

FIG. 9 shows an example of created mail, and FIG. 10 shows an example of mail that has been created for a user different from the example of FIG. 9. As shown in the figures, a list of “Document No.”, “Rev”, “Document Title”, “Document Type”, “Product Type”, and “Product Name” of the document information that has reached the document disclosure date is displayed in the created mail. As can be understood from a comparison between the mail of FIG. 9 and that of FIG. 10, if access rights of users differ from each other, a piece of document information to be displayed in created mail in the form of a list becomes different from another one even in the pieces of document information that have reached the document disclosure date on the same day.

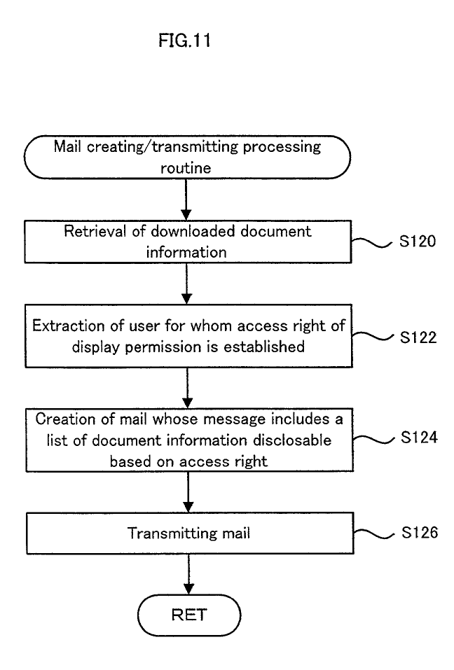

Next, a description will be given of processing for creating and transmitting, to a registered client, mail to the effect that document information concerning the fact that information has begun to be provided from the second information providing server 42 of the second embodiment has been generated. FIG. 11 is a flowchart showing an example of a mail creation/transmission processing routine performed by the second information providing server 42. This routine is performed at a predetermined time (e.g., 11 a.m.) on a date when the document information has been downloaded. Except for a first step (Step S120), the mail creation/transmission processing routine performed by the second information providing server 42 is the same as the mail creation/transmission processing routine performed by the first information providing server 32 shown in FIG. 8. In the second information providing server 42, when this routine is performed, processing for retrieving the document information downloaded on the date is first performed (Step S120). As described above, in the first information providing server 32 of the first embodiment, processing for retrieving the document information that has reached the document disclosure date is performed by accessing the database 34. Since the document information concerned is downloaded to the database 44 of the second information providing server 42 at a predetermined time on the document disclosure date, the retrieval of the document information downloaded by the second information providing server 42 brings about the same result as the retrieval of the document information that has reached the document disclosure date. The procedure (Steps S122-S126) following this retrieval of the document information is the same as the procedure of the routine of FIG. 8 (Steps S112-S116), and therefore a description thereof is omitted to avoid the repetition thereof.

According to the first information providing server 32 of the first embodiment and the second information providing server 42 of the second embodiment described above, a user (client) who has received a transmitted mail and has obtained information can know from the message of the mail that new providable document information exists, without accessing the first information providing server 32 or the second information providing server 42.

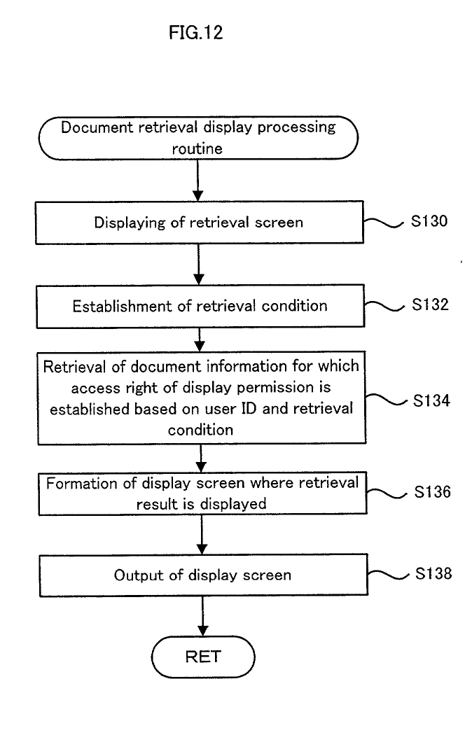

Next, a description will be given of processing performed when a user who has received mail demands of the first information providing server 32 of the first embodiment and the second information providing server 42 of the second embodiment that the document information be provided through the intranet 10 or the Internet 20. FIG. 12 is a flowchart showing an example of a document retrieval/display processing routine performed when a list of documents that can be provided to a client that has performed a login procedure is displayed. This routine is performed when clients 12 to 16 and clients 22 to 26 perform a login procedure to a document information providing site that is provided by the first information providing server 32 and the second information providing server 42 through the intranet 10 or the Internet 20.

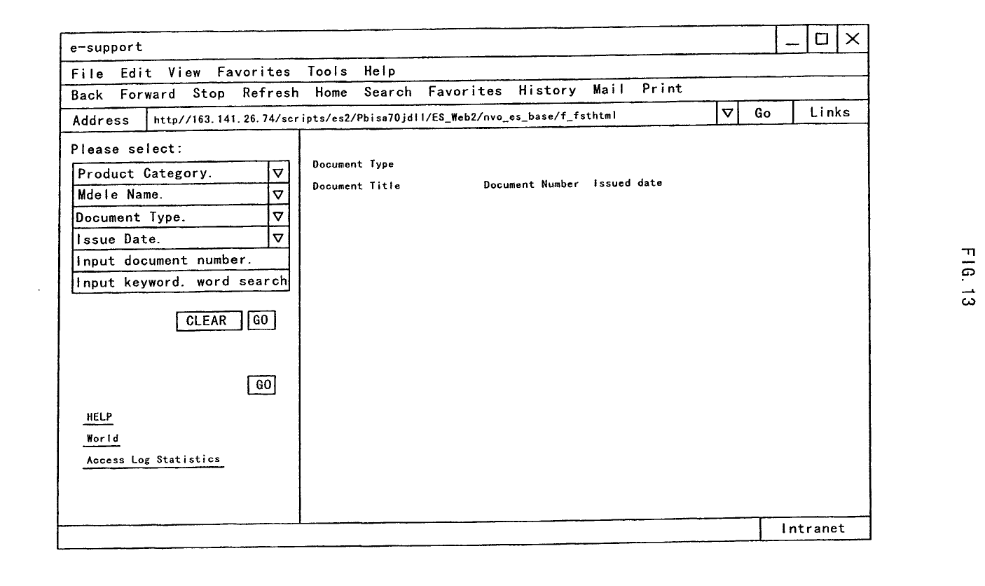

In performing this routine, the first and second information providing servers 32 and 42 of the first and second embodiments first display a retrieval screen (Step S130), and then perform processing for establishing a retrieval condition (Step S132). FIG. 13 shows an example of the retrieval screen. In the retrieval screen of FIG. 13, the retrieval condition is input by choosing a desired product category or model name from the pull-down menu and by inputting it to the input box of “Product Category” or “Model Name” appearing on the left side of the figure. When the retrieval condition is input, and the button “GO” is chosen, document information in which the access right of display permission has been established is retrieved from the database 34 or the database 44 on the basis of the user ID input when the user has performed the login procedure and on the basis of the input retrieval condition (Step S134). When the document information is retrieved from the database 34 of the first information providing server 32, a document disclosure date established for displaying the document information is also retrieved as a retrieval condition, depending on the access right established for the user. Therefore, a user who has only an access right according to which document information that has not reached the document disclosure date cannot be displayed retrieves only the document information that has reached the document disclosure date. When the document information is retrieved from the database 44 of the second information providing server 42 of the second embodiment, the document information is downloaded to the database 44 at a predetermined time on the document disclosure date. Therefore, all the document information registered in the database 44 has reached the document disclosure date, and there is no need to set the document disclosure date as a retrieval condition.

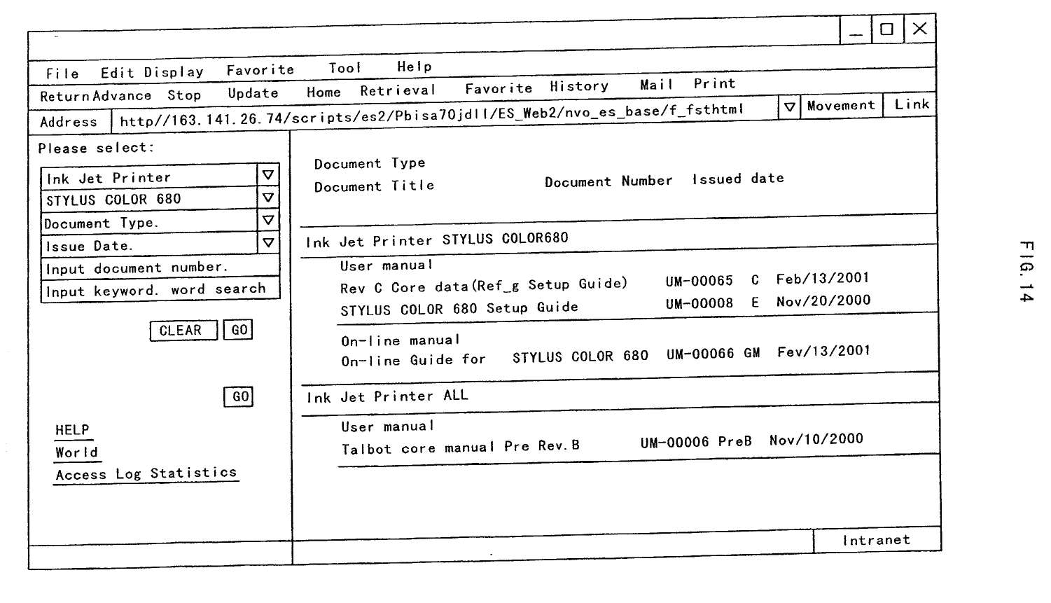

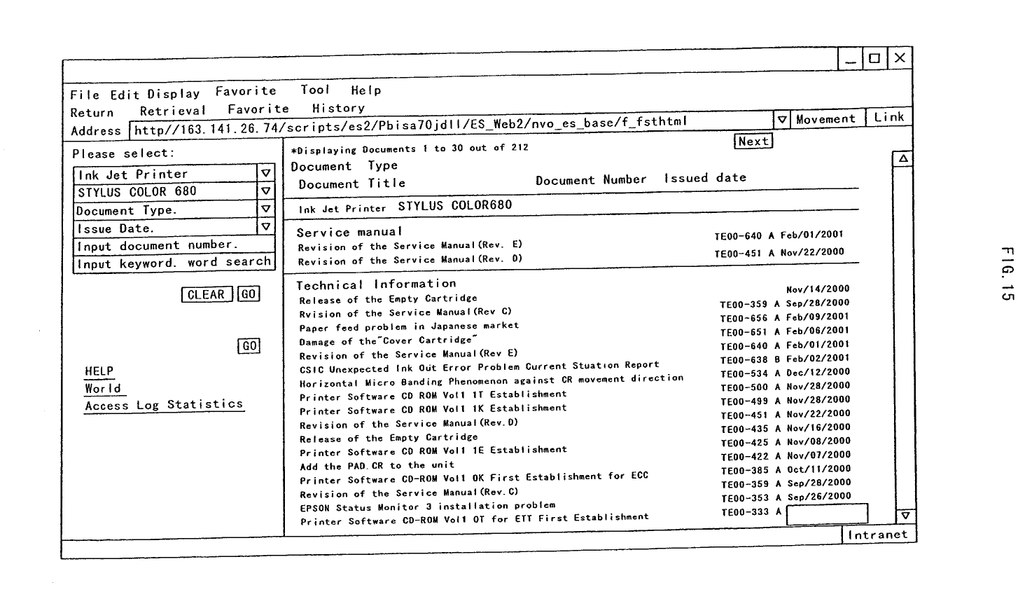

Thereafter, a display screen (retrieval result display screen) for displaying only a list of retrieved documents is formed (Step S136), the formed retrieval result display screen is then output to the side of a client (Step S138), and this routine is ended. Since the retrieval result depends on an access right or depends on a document disclosure date to be established, the retrieval result display screen is formed every time and is output to the client side. FIG. 14 and FIG. 15 each show an example of the retrieval result display screen that is formed for and is output to users to whom different access rights are granted. As shown in the figures, different retrieval results are obtained for users who have different access rights, respectively, in spite of the fact that information is retrieved by using the same model name under the same product category. Therefore, different retrieval result display screens are displayed. The retrieval result display screen by the first information providing server 32 of the first embodiment or by the second information providing server 42 of the second embodiment is designed to display a list of documents, with the group to which each of the documents belongs as a unit. This group is input by choosing the tag of “Document Information” of the document registration dialog shown in FIG. 6 and by inputting a group name into the input box of “Document Classification”, not shown, by selection from the pull-down menu.

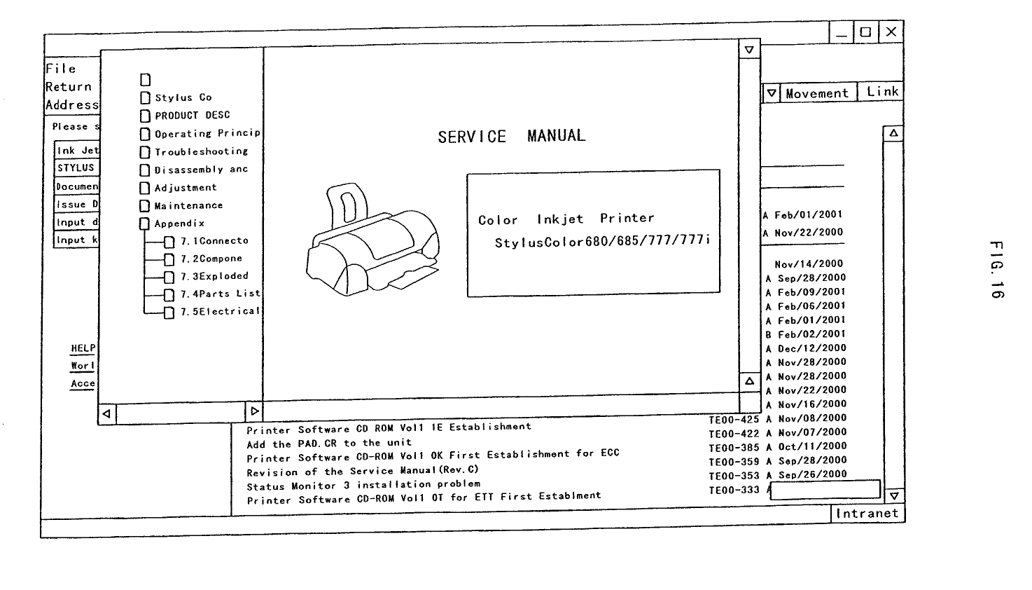

The screen displayed in this way can display a chosen document by selection from the list of documents. In more detail, when a pointer of a pointing device points to a desired document of the displayed document list, the shape of the pointer is changed from “Arrow” to “Hand”, which indicates that the document can be selected. When the document pointed by the pointing device is selected, a display screen of the selected document is output as shown in FIG. 16. Thus, the client can cause the screen to display the desired document within the range of access rights.

According to the first information providing server 32 of the first embodiment and the second information providing server 42 of the second embodiment described above, when a demand to provide document information is made from clients 12 to 16 and 22 to 26 through the intranet 10 and the Internet 20, document information in which the access right of display permission has been established is retrieved on the basis of a user ID, which has been input when the user performs a login procedure, and on the basis of a retrieval condition that has been input, and a retrieval-result-list-displaying screen that displays only the list of the retrieved documents is formed and displayed. Therefore, the document information that is provided in accordance with the access right can be more appropriately displayed in the form of a list. As a result,clients can easily select providable information.

According to the first information providing server 32 of the first embodiment, the document disclosure date that has been established for displaying the document information is also retrieved as a retrieval condition. Therefore, only the list of document information that has reached the document disclosure date can be displayed to users who have only an access right according to which the document information that has not reached the document disclosure date cannot be displayed.

Additionally, the double-server system 30 is made up of the first information providing server 32 of the first embodiment and the second information providing server 42 of the second embodiment, and document information is downloaded from the first information providing server 32 to the second information providing server 42 at a predetermined time on a document disclosure date, thereby making it possible to prevent document information that has not reached the document disclosure date from being provided through the Internet 20 by an illegal access to the second information providing server 42 of the second embodiment. That is, high security can be achieved. Further, clients 12 to 16 can be hierarchized by establishing the access rights for clients 12 to 16 having access to the first information providing server 32 of the first embodiment through the intranet 10, and the clients 22 to 26 can be hierarchized by establishing access rights for clients 22 to 26 having access to the second information providing server 42 of the second embodiment through the Internet 20. Moreover, both access rights for clients 12 to 16 having access to the first information providing server 32 of the first embodiment and the access rights for clients 22 to 26 having access to the second information providing server 42 of the second embodiment can be uniformly established by using the document registration dialog. Therefore, access rights for clients 22 to 26 do not need to be established by the second information providing server 42.

As mentioned above, in the embodiments, the double-server system 30 is made up of the first information providing server 32 of the first embodiment and the second information providing server 42 of the second embodiment. However, it is permissible to form the first and second information providing servers 32 and 42 of the first and second embodiment each as an independent structure.

In the first and second information providing servers 32 and 42, mail is created and transmitted on the basis of an access right. If no access right is established to document information, a document that is retrieved on the basis of a document disclosure date and on the basis of downloading may be transmitted to all of the registered users (clients) by creating mail.

In the first information providing server 32 of the first embodiment and the second information providing server 42 of the second embodiment, a message to the effect that there is new document information to be provided is transmitted in the form of mail. Instead, the message including the effect may be transmitted to registered users (clients) through a medium other than the mail.

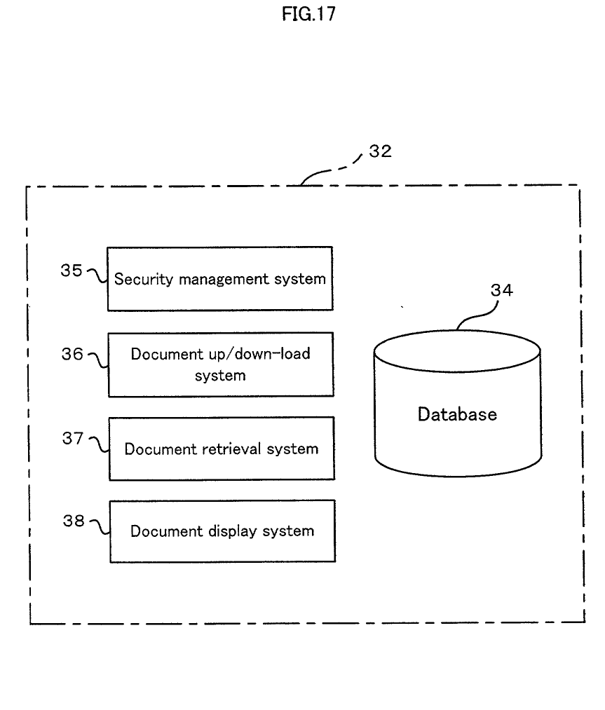

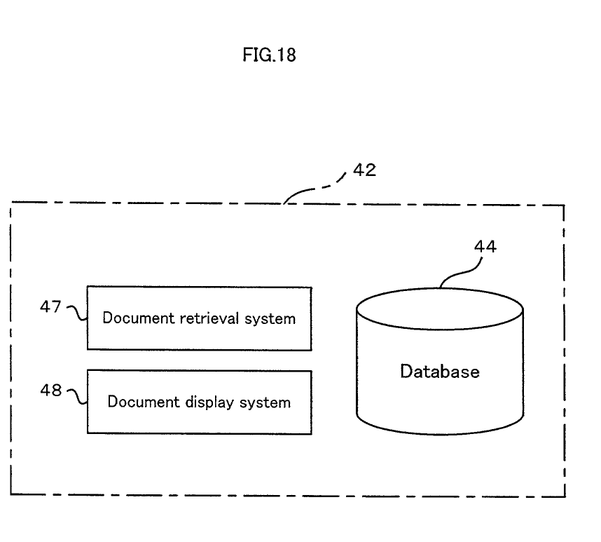

As mentioned above, in the first information providing server 32 of the first embodiment and the second information providing server 42 of the second embodiment, document information that has reached a document disclosure date is retrieved, and then mail created and transmitted on the basis of an access right, or downloaded document information is retrieved, and then mail is created and transmitted on the basis of an access right. However, it is permissible not to perform such mail creation/transmission processing. If so, the first information providing server 32 of the first embodiment may be made up of, as shown in a modification of FIG. 17, a database 34, a security management system 35, an up/down-load system 36, a document retrieval system 37, and a document-displaying system 38, without disposing a mail-transmitting system 39, whereas the second information providing server 42 of the second embodiment may be made up of, as shown in a modification of FIG. 18, a database 44, a document retrieval system 47, and a document-displaying system 48, without disposing a mail-transmitting system 49. According to these structures, effects other than an effect brought about by the notification of the document disclosure date by mail can be achieved.

As mentioned above, in the first information providing server 32 of the first embodiment and the second information providing server 42 of the second embodiment, a list of retrieved documents is displayed with the group to which each document belongs as a unit. However, the document list maybe displayed without being classified into groups.

In the first information providing server 32 of the first embodiment, a system management user in the broad classification of the intranet 10 is set as a user who has an access right by which a document can be uploaded or the document authority of all documents can be established or changed, and an intranet user other than the system management user is set as a user who has an access right by which a document can be uploaded or as a user who has an access right by which the setting and changing with respect to an Internet user of the document authority over the document uploaded by the intranet user can be performed within a range of access rights established by the system management user, and, in addition, an Internet user is set as a user who can display a document through the Internet 20 within a range where an access right is established by the system management user and the intranet user. However, without being limited to these access rights, the present invention may establish various access rights.

In the first information providing server 32 of the first embodiment, both the product model disclosure date of a product model and the document disclosure date of a document are established. Instead, only the document disclosure date of a document may be established. Further, although the document disclosure date of a document is established in the first information providing server 32, the date and time, i.e., the document disclosure date and time may be established instead of only the date. In this case, document information from the first information providing server 32 to the second information providing server 42 should be downloaded at the document disclosure date and time.

In the first information providing server 32 of the first embodiment, aright to access a document is established according to a user classification as a broad classification and according to a reference group as a sub-classification that are used to establish document authority. Instead, the right may be established according to each user. Additionally, an access right by which only a part of document information can be displayed may be established as document authority.

As mentioned above, in the first information providing server 32 of the first embodiment and the second information providing server 42 of the second embodiment, document information is provided to the intranet 10 and the Internet 20. Instead, information other than the document information may be provided.

As mentioned above, in the first information providing server 32 of the first embodiment and the second information providing server 42 of the second embodiment, information is provided to clients 12 to 16 and 22 to 26 through the intranet 10 and the Internet 20. However, any network can be used to provide information without being limited to the intranet and the Internet.

A description has been given of the first information providing server 32 and the second information providing server 42 as the embodiments of the present invention. The present invention can take the form of an information providing method that has each step corresponding to each processing in the first and second information providing servers 32 and 42 of the embodiments, or can take the form of a storage medium that stores a program according to which a computer is caused to function as the first information providing server 32 or the second information providing server 42. If taken as such a storage medium, processing among the aforementioned processings that corresponds to the first or second information providing server 32 or 42 should be described by a suitable programming language at each step and be stored on, for example, a CD-ROM. Further, since the information provision by the first and second information providing servers of the embodiments can be performed in the form of an information providing site, it is permissible to take the form of the information providing site.

The present invention has been described with reference to the preferred embodiments as above. However, without being limited to these embodiments, the present invention can be, of course, embodied in various forms within a range not departing from the spirit of the present invention.

What is claimed is:

1. An information providing server for providing information to a client through a network, the information providing server comprising:
an information storage part for storing predetermined information that includes an access right of a client as a part of the information;
an information retrieval part for retrieving information to be provided from the predetermined information stored in the information storage part on the basis of the access right of the client concerning the demand when the client demands that the predetermined information be provided through the network;
a display screen forming part for forming a display screen of a list of the retrieved information; and
a display screen providing part for providing a list-displaying screen that has been formed to the client concerning the demand.

2. An information providing server in accordance with claim 1, wherein the display screen forming part forms a list-displaying screen that displays a list of only the retrieved information.

3. An information providing server in accordance with claim 1, wherein
the predetermined information includes a group to which the information belongs as a part of the information; and
the display screen forming part forms a list-displaying screen that displays a list of the retrieved information, with the group as a unit, based on the group to which the information belongs.

4. An information providing server in accordance with claim 1,
wherein the display screen forming part forms a list-displaying screen by which any of the retrieved information can be selected;
the information providing server further comprising an information providing part for providing the selected information to the client concerning the demand when the client concerning the demand selects information by using the list-displaying screen.

5. An information providing server in accordance with claim 1, wherein
the predetermined information includes provided time at which information begins to be provided as a part of the information; and
the information retrieval part retrieves information that has reached the provided time from among the predetermined information.

6. An information providing server in accordance with claim 5, wherein the provided time is set as a provided date at which information begins to be provided.

7. An information providing server in accordance with claim 1, wherein the predetermined information is document information.

8. A storage medium storing a program according to which a computer is caused to function as an information providing server,
the information providing server comprising: an information storage part for storing predetermined information that includes an access right of a client as a part of the information; an information retrieval part for retrieving information to be provided from the predetermined information stored in the information storage part on the basis of the access right of the client concerning the demand when the client demands that the predetermined information be provided through a network; a display screen forming part for forming a display screen of a list of the retrieved information; and a display screen providing part for providing a list-displaying screen that has been formed to the client concerning the demand.

9. An information provision site for providing predetermined information to a client through a network, the information provision site comprising:
a demand reception page for receiving a demand that the predetermined information be provided; and
a list-displaying page for retrieving related predetermined information from an information storage part that stores the predetermined information on the basis of an access right that has been established for a client concerning the demand when the demand is received and for forming and displaying a screen of a list of the retrieved information.

10. A storage medium storing a program according to which a computer is caused to function as a server for an information provision site,
the information provision site providing: a demand reception page for receiving a demand that the predetermined information be provided; and a list-displaying page for retrieving related predetermined information from an information storage part that stores the predetermined information on the basis of an access right that has been established for a client concerning the demand when the demand is received and for forming and displaying a screen of a list of the retrieved information.

11. An information providing method for providing information to a client through a network, the method comprising the steps of:
(a) storing predetermined information that includes an access right of a client as a part of the information;
(b) retrieving information to be provided from the predetermined information stored in the information storage part on the basis of the access right of the client concerning the demand when the client demands that the predetermined information be provided through the network;
(c) forming a display screen of a list of the retrieved information; and
(d) providing a list-displaying screen that has been formed to the client concerning the demand.

12. An information providing server that can provide information to a registered client through a network, the information providing server comprising:
an information storage part for storing document information about a plurality of documents that includes an access right of the client and a document disclosure date, each as a part of the information;
a retrieval part for retrieving document information that has reached the disclosure date from among the document information stored in the information storage part;
a client extraction part for extracting a client having an access right with respect to the retrieved document information; and
a mail creation part for creating mail that includes a notification of the retrieved document information for the extracted client.

13. A storage medium storing a program according to which a computer is caused to function as an information providing server that can provide information to a registered client through a network,
the information providing server comprising: an information storage part for storing document information about a plurality of documents that includes an access right of the client and a document disclosure date, each as a part of the information; a retrieval part for retrieving document information that has reached the disclosure date from among the document information stored in the information storage part; a client extraction part for extracting a client having an access right with respect to the retrieved document information; and a mail creation part for creating mail that includes a notification of the retrieved document information for the extracted client.

14. An information providing method for providing information to a registered client through a network, the method comprising the steps of:
(a) storing document information about a plurality of documents that includes an access right of the client and a document disclosure date, each as a part of the information;
(b) retrieving document information that has reached the disclosure date from among the document information stored in the information storage part;
(c) extracting a client having an access right with respect to the retrieved document information; and
(d) creating mail that includes a notification of the retrieved document information for the extracted client.

15. An information providing server that can provide information to registered clients through a network, the information providing server comprising:
an information storage part for storing predetermined information that includes provided time at which information is provided as a part of the information;
an information retrieval part for retrieving predetermined information that has reached the provided time from among the predetermined information stored in the information storage part; and
a message-outputting part for outputting, to the registered clients, a message to the effect that the predetermined information is provided, when the predetermined information that has reached the provided time is retrieved.

16. An information providing server in accordance with claim 15, wherein the provided time is set as a provided date at which information is provided.

17. An information providing server in accordance with claim 15, wherein the message-outputting part creates an e-mail that includes a message to the effect that the predetermined information stored in the information storage part is provided, and transmits the e-mail to the registered clients.

18. An information providing server in accordance with claim, wherein
the predetermined information includes an access right of the client as a part of the information; and
the message-outputting part outputs a message to one of the registered clients who has obtained permission of information provision in accordance with the access right that is partly included in retrieved predetermined information.

19. A storage medium storing a program according to which a computer is caused to function as an information providing server that can provide information to registered clients through a network,
the information providing server comprising: an information storage part for storing predetermined information that includes provided time at which information is provided as a part of the information; an information retrieval part for retrieving predetermined information that has reached the provided time from among the predetermined information stored in the information storage part; and a message-outputting part for outputting to the registered clients a message to the effect that the predetermined information is provided when the predetermined information that has reached the provided time is retrieved.

20. An information providing method for providing information to registered clients through a network, the method comprising the steps of:
(a) storing predetermined information that includes provided time at which information is provided as a part of the information;
(b) retrieving predetermined information that has reached the provided time from among the predetermined information stored in the information storage part; and
(c) outputting to the registered clients a message to the effect that the predetermined information is provided, when the predetermined information that has reached the provided time is retrieved.

21. An information providing server that can provide information to registered clients through a network, the information providing server comprising:
an information storage part for storing predetermined information that has been output from another server; and
a message-outputting part for outputting, to the registered clients, a message to the effect that the predetermined information is provided, at the time at which the predetermined information is stored in the information storage part and/or at a predetermined time after the predetermined information has been stored.

22. An information providing server in accordance with claim 21, wherein the message-outputting part creates an e-mail that includes a message to the effect that the predetermined information stored in the information storage part is provided, and transmits the e-mail to the registered clients.

23. An information providing server in accordance with claim 21, wherein
the predetermined information includes an access right of the client as a part of the information, and
the message-outputting part outputs a message to one of the registered clients who has obtained information provision permission in accordance with the access right that is partly included in retrieved predetermined information.

24. A storage medium storing a program according to which a computer is caused to function as an information providing server that can provide information to registered clients through a network,
the information providing server comprising: an information storage part for storing predetermined information that has been output from another server; and a message-outputting part for, at time at which the predetermined information is stored in the information storage part and/or at a predetermined time after the predetermined information has been stored, outputting, to the registered clients, a message to the effect that the predetermined information is provided.

25. An information providing method for providing information to registered clients through a network, the method comprising the steps of:
(a) storing predetermined information that has been output from another server; and
(b) outputting, to the registered clients, a message to the effect that the predetermined information is provided, at the time at which the predetermined information is stored in the information storage part and/or at a predetermined time after the predetermined information has been stored.
